(19) United States
(12) Patent Application Publication
(10) Pub. No.: US 2009/0033114 A1
(43) Pub. Date: Feb. 5, 2009

(54) Loading area cover for a motor vehicle

(76) Inventors: Thomas Steigerwald, Rochester Hills, MI (US); Michael Uhazie, Oakland Township, MI (US)

Correspondence Address: FLYNN THIEL BOUTELL & TANIS, P.C., 2026 RAMBLING ROAD, KALAMAZOO, MI, 49008-1631, US

(21) Appl. No.: 11/888,908

(22) Filed: Aug. 2, 2007

(51) Int. Cl. B60P 7/04

(52) U.S. Cl. 296/24.4

(57) ABSTRACT

A loading area cover with a flexible flat structure, at a front end region, is connected to a dimensionally stable holding profile. The profile extends transversely to the flat structure's longitudinal direction and is releasably arranged in vehicle-fixed holders. The holding profile has frontal compensating elements in the vicinity of the vehicle-fixed holders, through which the front end region of the flat structure, or the dimensioning of the holding profile, can be displaced to a limited extent in the transverse direction and/or longitudinal direction.

The invention relates to a luggage or loading area cover for a motor vehicle having a flexible flat structure, which at least one front end region is connected to in each case one dimensionally stable holding profile extending transversely to the longitudinal direction of the flat structure and which is releasably placed in vehicle-fixed holders.

Loading area covers in which a flexible flat structure extends between two dimensionally stable holding profiles, which in each case are connected to the opposite front end regions of the flexible flat structure are generally known. Such loading area covers are extremely simply constructed and therefore inexpensive. They are inserted by their two holding profiles in the vehicle-side holders, which for the facing holding profiles are so mutually spaced in the vehicle longitudinal direction that the flat structure is fixed in a roughly horizontally fixed position spanning the loading area just below a vehicle shoulder. Vehicle-side tolerances of the arrangement of the holders can consequently lead to a holding profile on its opposite lateral edges with which it is inserted in the vehicle-side holders, not being adequately secured. Moreover tolerances in the spacings of the vehicle-side holders with respect to one another in the vehicle longitudinal direction can lead to the flat structure sagging loosely in the fixed covering state, which gives a poor optical impression.

The problem of the invention is to provide a loading area cover of the aforementioned type, which at least partly permits a compensation of tolerances in the arrangement of the vehicle-fixed holders.

This problem is solved in that the holding profile has frontal compensating elements in the vicinity of the vehicle-fixed holders through which the at least one front end region of the flat structure can be displaced to a limited extent in the transverse and/or longitudinal direction. This makes it possible to compensate tolerances in the arrangement of the vehicle-fixed holders in the vehicle transverse direction and/or vehicle longitudinal direction. This makes it possible to achieve a flat and planar, taut surface structure state when the latter is in the covering position. It is also possible as a result of the compensating elements to vary within clearly defined limits the longitudinal extension of the holding profile, i.e. in the vehicle transverse direction, so that even in vehicle-fixed holders, which facing one another have a somewhat greater spacing than other vehicle-fixed holders, the holding profile has a reliable seating in said holders. Thus, the flat structure is also transversely displaceable, because it is held on the holding profile. The inventive solution makes possible either a tolerance compensation only in the vehicle transverse or vehicle longitudinal direction, or a tolerance compensation in both the vehicle transverse and longitudinal directions.

According to a development of the invention with the compensating elements are in each case associated end stops and spring loading means, which apply spring tension in at least one direction to the associated compensating element and in the unloaded state are held on an end stop. This leads to a play-free seating of the holding profiles in the vehicle-fixed holders. The spring loading means permit the tensioning of the surface structure in its functional position covering the loading area.

According to a further development of the invention in the transverse direction of the flat structure the compensating elements embrace a telescopic profile section. The telescopic profile sections are preferably coaxially integrated into the given holding profile.

In a further development of the invention, in the longitudinal direction of the flat structure, the compensating elements have a longitudinal guidance section held in stationary manner with respect to the vehicle-fixed holders, as well as a sliding carriage section arranged in fixed manner on the front end region and longitudinally movable to a limited extent relative to the longitudinal guidance section. The limitedly longitudinally movable sliding carriage section permits the tolerance compensation in the vehicle longitudinal direction, i.e. the flat structure longitudinal direction.

In a further development of the invention the compensating elements for in each case a front side of the holding profile form part of a preassembled functional unit. This makes it possible to preassemble the compensating elements together with the holding parts, which ensure the seating in the given vehicle-fixed holders and to frontally insert the same in the holding profiles preferably in the form of hollow profiles. Thus, a corresponding, preassembled functional unit comprises both the compensating functions in the longitudinal direction and/or transverse direction of the flat structure and also holding functions for securing the holding profiles in the vehicle-fixed holders.

In a further development of the invention the front end region of the flat structure facing the holding profile is connected to a dimensionally stable extraction profile, which is releasably held in further vehicle-side receptacles remote from the first, vehicle-fixed holders. The further holding profile in the form of the extraction profile can be designed without a compensating function. However, it is also possible to provide said facing extraction profile with inventive compensating elements in the longitudinal and/or transverse direction. Preferably with a loading area accessible from the rear region the front end region of the flat structure, considered in the normal travel direction, is equipped with a holding profile having compensating elements in the sense of the invention. However, the rear extraction profile facing the rear or back region has no compensating functions. This extraction profile is normally removed from the rear-side holders by an operator and in the vicinity of the front holding profile is inserted again or positioned in some other way to give free access to the loading area. In the same way, the corresponding operator reinserts the extraction profile in the rear-side holders.

Further advantages and features of the invention can be gathered from the claims and the following description of a preferred embodiment of the invention and the attached drawings, wherein show:

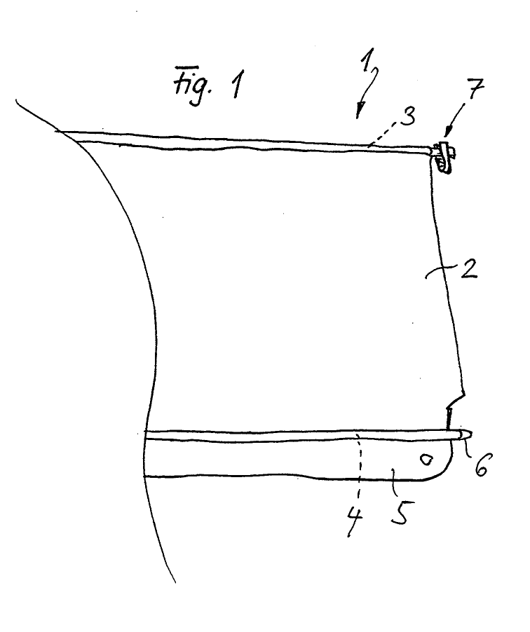

FIG. 1 In a perspective view a partial area of the embodiment of an inventive loading area cover.

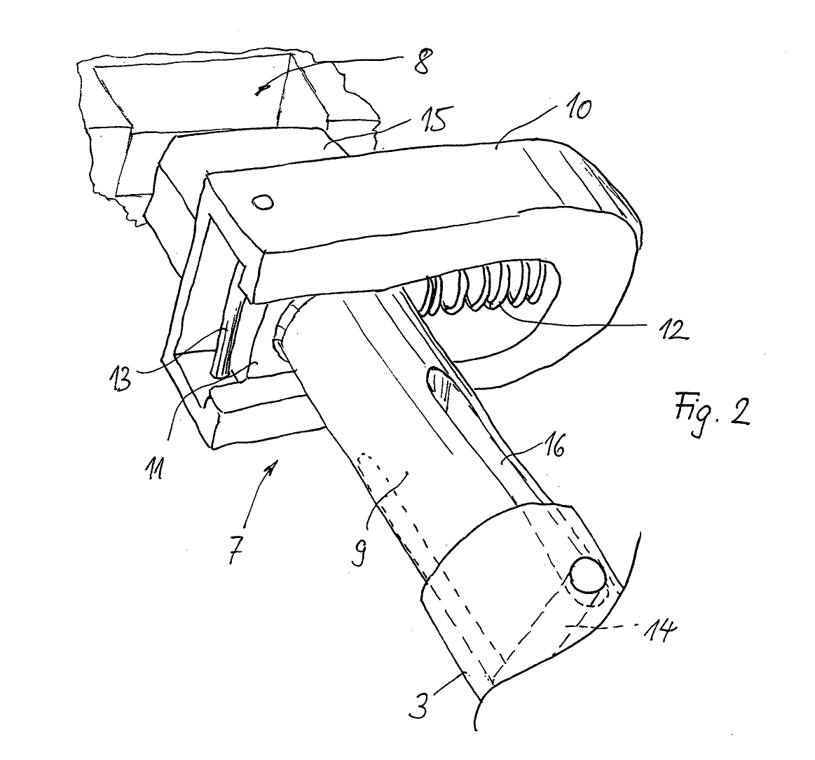

FIG. 2 A larger scale, perspective view of the front end region of a holding profile of the loading area cover of FIG. 1.

A loading area cover 1 according to FIG. 1 has a flexible flat structure 2 in the form of a textile or plastic tarpaulin. A length of the flat structure 2 is roughly dimensioned in such a way that said flat structure 2 in a functional position in which it extends roughly horizontally over a loading area of a motor vehicle, covers virtually the entire length and virtually the entire width of the loading area. The flat structure is provided with a holding profile 3 on a front end region in the vehicle longitudinal direction. The flat structure 2 is fixed to the holding profile 3, in that it is preferably wound around the holding profile 3 and is sewn in the vicinity of the latter. Alternatively a corresponding front end region of the flat structure 2 can be provided with a welt, which engages in a corresponding welt groove or channel of the holding profile 3, so as to bring about fastening to the latter.

A front end region of the flat structure 2 at the back in the vehicle longitudinal direction is connected to an extraction profile 4 which, like holding profile 3, is dimensionally stable. A dimensionally stable contour part 5 is connected to extraction profile 4.

In its opposite front edge sections the holding profile 3 is in each case provided with a functional unit 7, whereby FIGS. 1 and 2 only show the right-hand functional unit 7 considered in the direction of travel. The complete left-hand side of the loading area cover 1 is designed in mirror-symmetrical form in the same way as the right-hand side. It was therefore considered unnecessary to also show the left-hand side in FIGS. 1 and 2.

With the functional unit 7 of holding profile 3 are associated vehicle-side holders 8 (FIG. 2) which are constructed as recesses. As a function of the design of recesses 8, the functional unit 7 can be inserted in the latter from above or in the vehicle transverse direction, as will be explained in greater detail hereinafter.

In its opposite front edge regions the extraction profile 4 is provided with simple pins 6, which in known manner can be suspended in vehicle-side hangings in the vehicle rear region.

Holding profile 3 is constructed as a cylindrical hollow profile, which is open at its opposite front sides. Into the hollow profile 3 is coaxially inserted a telescopic rod section 9, which is provided with a longitudinal slot 16 constant over its thickness in the flat structure transverse direction and therefore the longitudinal extension of holding profile 3. Holding profile 3 is provided with an end stop in the form of a stop pin 14, which passes through longitudinal slot 16 and consequently limits the telescopability of telescopic section 9 relative to holding profile 3. Telescopic section 9 is linearly displaceably guided in holding profile 3 over the length of longitudinal slot 16.

The rod-like telescopic section 9 is provided in its front end region remote form holding profile 3 with a sliding block 11, which is in the form of a slidable carriage element within a guide rail section 10. Sliding block 11 is linearly displaceable to a limited extent in a corresponding guide groove of guide section 10, open towards holding profile 3, in the flat structure longitudinal direction and therefore also in the vehicle longitudinal direction. The guide section 10 is constructed as an integral housing part, which is closed at one end, so that the guide groove is limited or bounded by a corresponding marginal area at said one end. The guide groove of guide housing 10 is open to the opposite side, as can be seen in FIG. 2. In the direction of the open region of the guide groove the sliding block 11 is bounded by a stop pin 13, which is oriented upwards in the guide housing 10 and is fixed in the latter. Thus, the sliding block 11 can be moved between the stop pin 13 serving as an end stop and the rear marginal area of guide housing 10 in the flat structure longitudinal direction and therefore also vehicle longitudinal direction. The sliding block 11 is permanently spring-loaded by a helical compression spring 12, which exerts a spring pressure in the flat structure longitudinal direction and which is on the one hand supported on sliding block 11 and on the other on the marginal area of guide housing 10. The helical compression spring 12 is designed in such a way that it maintains the sliding block 11, in the unloaded position, in play-free manner on end stop 13.

The telescopic section 9 can also be axially loaded by spring tension is not shown manner in order to be preferably permanently axially outwardly loaded.

On its outside facing telescopic section 9 or the guide groove, guide housing 10 has a parallelepipedic holding block 15, which is integrally shaped on guide housing 10 and projects outwards from the latter in the vehicle transverse direction. A recess 8 as a vehicle-side holder in the vicinity of a side wall of the vehicle loading area is associated with holding block 15 and is matched to the extension dimensions of said block 15. In the embodiment shown the recess 8 is upwardly open, so that the holding block 15 can be inserted in the recess from above.

In a not shown embodiment of the invention the recess 8 is only open to the loading area centre, which leads to a parallelepipedic pocket only open towards the holding block 15 and which can be transversely inserted or engaged in said block 15. Due to the fact that recess 8 is matched to the dimensions of holding block 15, the latter is positively housed in recess 8. It can be extracted again by merely pulling out in the transverse direction of the flat structure, i.e. in the longitudinal extension of holding profile 3.

Thus, with the guide housing 10, telescopic section 9, sliding block 11 and holding block 15 the functional unit 7 has several functions. Through the telescopic section 9 it is possible to vary relative to the holding profile 3 the length of the latter or the position of the holding block 15, considered in the holding profile longitudinal extension. Thus, also facing, vehicle-side holders, which are somewhat further removed from one another than other vehicle-side recesses can still lead to a reliable insertion of the given holding block 15 of functional unit 7 and therefore a reliable locking of holding profile 3 in the vehicle-side holders. In the assembled state of guide housing 10, i.e. in the position of holding block 15 inserted in recess 8, the guide housing 10 is held in stationary manner, whereas the sliding block 11 is longitudinally displaceable to a limited extent in the flat structure longitudinal direction and therefore vehicle longitudinal direction. This makes it possible to tension the flat structure 2 in the extended functional position. This permits a tolerance compensation in the longitudinal direction of flat structure 2. The holding block 15 shaped onto or in some other way rigidly fixed to the guide housing 10 fulfils a holding function for holding profile 3 to permit the locking in the vehicle-side holders. Thus, the functional unit 7 has a triple function.

The longitudinal mobility of telescopic section 9 in the reverse manner also serves to permit the removal again of holding profile 3 from the vehicle-side holders. To this end the two functional units 7 of the facing front end regions of holding profile 3 can be easily pressed inwards counter to the spring tension acting outwards on telescopic sections 9 and can be removed from the vehicle-side holders 8.

It is possible to preassemble the functional units 7 and then insert each functional unit 7 in the open front end region of holding profile 3. Following inserted and in simple manner the stop pin 14 is engaged through holding profile 3 and the longitudinal slot and is locked in said holding profile 3. Consequently the functional unit 7 is held on holding profile 3. If the telescopic section 9 is subject to an additional spring tension, preferably the corresponding spring element with which is associated its own support within the holding profile 3 is inserted in the latter prior to the insertion of telescopic section 9. Through the subsequent insertion of telescopic section 9 the spring element is pressurized, so that it permanently tries to force outwards telescopic section 9.

Following the insertion of functional unit 7 in vehicle-side holders the loading area cover 1 is functional. The extraction profile 4 directed towards the rear region can easily be gripped by hand and either positioned in the vicinity of functional unit 7 or in the vicinity of corresponding vehicle-side holders, so that the flat structure 2 drops downwards in a single loop. Alternatively the flat structure 2 can be transferred into its fixed functional position. For this purpose the contour part 5, including the extraction profile 4, is gripped and drawn rearwards towards the rear region until the holding pins 6 of extraction profile 4 can be suspended in the corresponding hangings. If the flat structure 2 is to be returned from this roughly horizontally fixed functional position to its loosely downwardly hanging rest position, the extraction profile 4 with its holding pins 6 is easily removed from the vehicle-side hangings. Preferably the spacing of the vehicle-side hangings from the vehicle-side recesses 8 for functional unit is dimensioned in such a way that on inserting the holding pins 6 the flat structure 2 must be tensioned in the vehicle longitudinal direction. As a result the flat structure draws rearwards in the vehicle longitudinal direction the holding profile 3, so that the helical compression springs 12 are loaded on both sides by means of telescopic sections 9 and sliding blocks 11. The compensating possibility in the vehicle longitudinal direction is also advantageous if the length of the flat structure 2 is not the same at its opposite lateral edges or if the spacings of the vehicle-side hangings are not exactly the same size as the vehicle-side recesses 8 for the functional unit 7 on both vehicle sides.

1. Loading area cover for a motor vehicle with a flexible flat structure, which at least one front end region is connected to in each case one dimensionally stable holding profile extending transversely to the flat structure longitudinal direction and which is releasably arranged in vehicle-fixed holders, wherein the holding profile (3) has frontal compensating elements (9 to 11) in the vicinity of the vehicle-fixed holders (8) through which the at least one front end region of flat structure (2) can be displaced to a limited extent in the transverse direction and/or longitudinal direction.

2. Loading area cover, wherein with the compensating elements (9 to 11) are in each case associated end stops (13, 14) and spring loading means (12), which subject the associated compensating element (9, 11) with spring tension in at least one direction and in the unloaded state maintain the same on the given end stop.

3. Loading area cover according to claim 1, wherein the compensating elements embrace a telescopic profile section (9) in the transverse direction of flat structure (2).

4. Loading area cover according to claim 1, wherein the compensating elements have in the longitudinal direction of flat structure (2) a longitudinal guidance section (10) held in stationary manner relative to the vehicle-fixed holders (8) and a sliding carriage section (11) longitudinally movable to a limited extent relative to the longitudinal guidance section 910) and a sliding carriage section (11) arranged in fixed manner on the front end region and longitudinally movable to a limited extent relative to the longitudinal guidance section (10).

5. Loading area cover according to claim 1, wherein the compensating elements (9 to 11) for in each case one front side of holding profile (3) form part of a preassembled functional unit.

6. Loading area cover according to claim 1, characterized in that the front end region of flat structure (2) facing holding profile (3) is connected to a dimensionally stable extraction profile (4), which is releasably held in further vehicle-side receptacles remote from the first, vehicle-fixed holders.

7. Loading area cover according to claim 6, wherein the extraction profile is designed as a holding profile with compensating elements according to at least one of the preceding claims.
